(19) United States
(12) Patent Application Publication
(10) Pub. No.: US 2014/0210407 A1
(43) Pub. Date: Jul. 31, 2014

(54) WIRELESS POWER APPARATUS, WIRELESS CHARGING SYSTEM USING THE SAME, AND POWER TRANSCEIVING METHOD

(71) Applicants: Do Hyun Won, Seoul (KR); Ki Min Lee, Seoul (KR)

(72) Inventors: Do Hyun Won, Seoul (KR); Ki Min Lee, Seoul (KR)

(73) Assignee: LG INNOTEK CO., LTD., Seoul (KR)

(21) Appl. No.: 14/346,901

(22) PCT Filed: Jul. 23, 2012
(86) PCT No.: PCT/KR2012/005867

§ 371 Date: Apr. 4, 2014

(30) Foreign Application Priority Data
Sep. 22, 2011 (KR) 10-2011-0095977

(51) Int. Cl. H02J 7/02; H01F 38/14

(52) U.S. Cl. CPC H02J 7/025; H01F 38/14
USPC 320/108; 307/104

(57) ABSTRACT

Disclosed are a wireless power apparatus, a wireless charging system using the same, and a power transceiving method. The wireless power apparatus using resonance includes a coil to wirelessly transceive power according to an operating mode of the wireless power apparatus, a power reception part to receive power through the coil, a power transmission part to transmit power through the coil, and a switch to connect one of the power reception part and the power transmission part to the coil according to the operating mode.

### TECHNICAL FIELD

The disclosure relates to a wireless power transmission technology. In more particular, the disclosure relates to a wireless power apparatus capable of effectively transmitting/receiving energy by using a resonance phenomenon, a wireless charging system using the same, and a power transceiving method.

### BACKGROUND ART

A wireless power transmission or a wireless energy transfer refers to a technology of wirelessly transferring electric energy to desired devices. In the 1800's, an electric motor or a transformer employing the principle of electromagnetic induction has been extensively used and then a method for transmitting electrical energy by irradiating electromagnetic waves, such as radio waves or lasers, has been suggested. Actually, electrical toothbrushes or electrical razors, which are frequently used in daily life, are charged based on the principle of electromagnetic induction. Until now, the long-distance transmission using the magnetic induction, the resonance and the short-wavelength radio frequency has been used as the wireless energy transfer scheme.

In the case of a short-distance wireless power transmission, which has been spotlighted in these days, a wireless power transmitter is installed in a building in such a manner that a mobile device, such as a cellular phone or a notebook computer, can be continuously charged when a user uses the mobile device in the building even if the mobile device is not connected to an additional power cable.

However, the wireless power receiver according to the related art only receives power from the wireless power transmitter, and cannot transmit power stored in the wireless power receiver to another receiver.

### DISCLOSURE OF INVENTION

### Technical Problem

The disclosure relates to a wireless power apparatus capable of transceiving energy by using a resonance phenomenon, a wireless charging system using the same, and a power transceiving method.

In addition, the disclosure relates to a wireless power apparatus capable of sharing power between receivers through a bi-directional wireless power transmission scheme, a wireless charging system using the same, and a power transceiving method.

In addition, the disclosure relates to a wireless power apparatus capable of reducing the deviation of energy between areas by using wireless power receivers having a bi-directional wireless power transmission function, a wireless charging system using the same, and a power transceiving method.

### Solution to Problem

According to the embodiment of the disclosure, there is provided a wireless power apparatus using resonance includes a coil to wirelessly transceive power according to an operating mode of the wireless power apparatus, a power reception part to receive power through the coil, a power transmission part to transmit power through the coil, and a switch to connect one of the power reception part and the power transmission part to the coil according to the operating mode.

According to another embodiment of the disclosure, there is provided a method of transceiving power of a wireless power apparatus including a power reception part and a power transmission part. The method includes measuring quantity of power stored in the power reception part, determining an operating mode of the wireless power apparatus based on the measured quantity of the power, and connecting one of the power reception part and the power transmission part to the coil according to the operating mode.

According to still another embodiment of the disclosure, there is provided a wireless charging system using a resonance phenomenon including a plurality of receivers to receive power from a transmitter or to transmit power to another receiver, a plurality of access points to wirelessly supply power to the receivers within coverage areas thereof and to determine a battery state of the receivers by using in-band communication with the receivers, and a power managing server to control an operation of wirelessly transmitting power from the power access points to the receivers based on battery states of the receivers.

### Advantageous Effects of Invention

As described above, according to the embodiment of the disclosure, the wireless power apparatus not only can receive power from a transmitter, but only transmit power to another receiver, so that the wireless power between receivers can be effectively shared.

In addition, according to the disclosure, the deviation of energy between areas can be reduced by using receivers having a bi-directional wireless power transmission function, and power management can be effectively performed.

Meanwhile, other various effects may be directly or indirectly disclosed in the detailed description according to the embodiment of the disclosure.

### BRIEF DESCRIPTION OF DRAWINGS

FIG. 1 is a view showing a wireless power transmission system according to one embodiment of the disclosure;

FIG. 2 is a circuit diagram showing a transmission coil according to one embodiment of the disclosure;

FIG. 3 is a circuit diagram showing an equivalent circuit of a wireless power transmitter according to one embodiment of the disclosure;

FIG. 4 is a circuit diagram showing an equivalent circuit of a wireless power receiver according to one embodiment of the disclosure;

FIG. 5 is a block diagram showing a wireless power receiver according to a first embodiment of the disclosure;

FIG. 6 is a block diagram showing the wireless power transmitter of FIG. 5 having a variable capacitor;

FIGS. 7(a) and 7(b) are views showing one scenario of a wireless charging system to reduce the deviation of energy between areas by using an electric vehicle having a bi-directional wireless power transmission function; and

FIG. 8 is a block diagram showing a wireless charging system to effectively perform power management in a company/public organization.

### BEST MODE FOR CARRYING OUT THE INVENTION

If detailed description about well known functions or configurations may make the subject matter of the disclosure unclear, the detailed description will be omitted. Accordingly, hereinafter, description will be made regarding only essential components directly related to the technical scope of the disclosure. In addition, terminologies to be described are defined based on functions of components according to the embodiment, and may have meanings varying according to the intentions of a user or an operator and customers. Accordingly, the terminologies should be defined based on the whole context throughout the present specification.

Hereinafter, the embodiment of the disclosure will be described with reference to accompanying drawings.

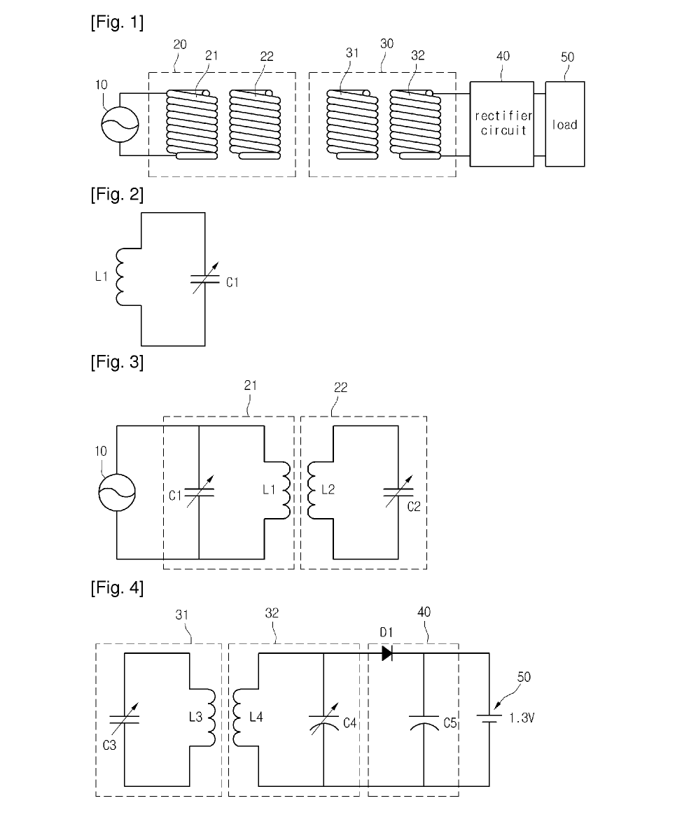

FIG. 1 is a view showing a wireless power transmission system according to one embodiment of the disclosure.

Referring to FIG. 1, the wireless power transmission system may include a power source 10, a power transmission part 20, a power reception part 30, a rectifier circuit 40, and a load 50.

Power generated from the power source 10 is transmitted to the power transmission part 20 and then transmitted to the power reception part 30 that makes resonance with the power transmission part 20, that is, has a resonant frequency value equal to that of the power transmission part 20 using resonance. The power transmitted to the power reception part 30 is transmitted to the load 50 through the rectifier circuit 40. The load 50 may be a battery or a device requiring the power.

In more detail, the power source 10 is an AC power source to provide AC power having a predetermined frequency.

The power transmission part 20 includes a transmission coil 21 and a transmission resonance coil 22. The transmission coil 21 is connected to the power source 10 and AC current flows through the transmission coil 21. As the AC current flows through the transmission coil 21, the AC current is induced to the transmission resonance coil 22, which is physically spaced apart from the transmission coil 21, through the electromagnetic induction. The power transmitted to the transmission resonance coil 22 is transmitted to the power reception part 30 which forms a resonant circuit together with the power transmitter 10 by resonance.

According to the power transmission using resonance, the power can be transmitted between two LC circuits which are impedance-matched. The power transmission scheme using the resonance can transmit the power farther than the power transmission scheme using the electromagnetic induction with the high power transmission efficiency.

The power reception part 30 includes a reception resonance coil 31 and a reception coil 32. The power transmitted through the transmission resonance coil 22 is received in the reception resonance coil 31 so that the AC current flows through the reception resonance coil 31. The power transmitted to the reception resonance coil 31 is transmitted to the reception coil 32 through the electromagnetic induction. The power transmitted to the reception coil 32 is rectified through the rectifier circuit 40 and then transmitted to the load 50.

The transmission resonance coil 22 of a wireless power transmitter can transmit power to the reception resonance coil 31 of a wireless power receiver through a magnetic field.

In detail, the transmission resonance coil 22 and the reception resonance coil 31 are resonance-coupled with each other so that the transmission resonance coil 22 and the reception resonance coil 31 operate at the same resonance frequency.

The resonance-coupling between the transmission resonance coil 22 and the reception resonance coil 31 can greatly improve the power transmission efficiency between the wireless power transmission part and the wireless power receiver.

FIG. 2 is a circuit diagram showing the transmission coil 21 according to one embodiment of the disclosure. As shown in FIG. 2, the transmission coil 21 may include an inductor L1 and a capacitor C1 and a circuit having predetermined inductance and capacitance values can be formed by using the inductor L1 and the capacitor C1.

The capacitor C1 may include a fixed capacitor or a variable capacitor. If the capacitor C1 is a variable capacitor, the power transmission part 20 may perform impedance matching by adjusting the variable capacitor. The equivalent circuit of the transmission resonance coil 22, the receiving resonant coil 31 and the receiving coil 22 may the same as the equivalent circuit shown in FIG. 2.

FIG. 3 is a view showing an equivalent circuit of the wireless power transmitter according to one embodiment of the disclosure.

Referring to FIG. 3, the wireless power transmitter includes the power source 10 and the power transmission part 20, and the power transmission part 20 includes the transmission coil 21 and the transmission resonance coil 22.

As shown in FIG. 3, the transmission coil 21 and the transmission resonance coil 22 may be constructed by using inductors L1 and L2 having predetermined inductance values and capacitors C1 and C2 having predetermined capacitance values.

In particular, the capacitor C2 of the transmission resonance coil 22 may include a variable capacitor, and the power transmission part 20 can adjust a resonance frequency value for resonance by adjusting the variable capacitor.

FIG. 4 is a circuit diagram showing a wireless power receiver according to the embodiment of the disclosure.

Referring to FIG. 4, the wireless power receiver includes the power reception part 30, the rectifier circuit 40, and the load 50. The power reception part 30 includes the reception resonance coil 31 and the reception coil 32.

As shown in FIG. 4, the reception resonance coil 31 and the reception coil 31 may be constructed by using inductors L3 and L3 having predetermined inductance values and capacitors C3 and C4 having predetermined capacitance values.

The rectifier circuit 40 may include a diode D1 and a smoothing capacitor C5 to convert AC power into DC power to be output. Although the load 50 is marked as a DC voltage source of 1.3V, the load 50 may include a predetermined rechargeable battery or a device requiring DC power.

The wireless power transmitter can adjust the power transmitted to the wireless power receiver by using in-band communication with the wireless power receiver.

The In-band communication refers to communication of exchanging information between the wireless power transmitter and the wireless power receiver through a signal having a frequency used in wireless power transmission. The wireless power receiver may receive or may not receive power transmitted from the wireless power transmitter through a switching operation. Accordingly, the wireless power transmitter detects the quantity of power consumed in the wireless power transmitter to recognize an on-signal or an off-signal of the wireless power receiver.

In detail, the wireless power receiver may change the power consumption in the wireless power transmitter by adjusting the quantity of power absorbed in a resistor by using the resistor and a switch. The wireless power transmitter detects the variation of the power consumption to acquire the state information of the wireless power receiver. The switch may be connected to the resistor in series.

In more detail, if the switch is open, the power absorbed in the resistor becomes zero, and the power consumed in the wireless power transmitter is reduced.

If the switch is closed, the power absorbed in the resistor becomes greater than zero, and the power consumed in the wireless power transmitter is increased. If the wireless power receiver repeats the above operation, the wireless power transmitter detects power consumed therein to make communication with the wireless power receiver.

The wireless power transmitter receives the state information of the wireless power receiver through the above operation so that the wireless power transmitter can transmit appropriate power. According to one embodiment, the state information of the wireless power receiver may include information of the quantity of power presently charged in the wireless power receiver, and the information of the variation in the charged quantity of the power.

A resistor and a switch are provided at the side of the wireless power transmitter, so that the state information of the wireless power transmitter may be transmitted to the wireless power receiver. In this case, in-band communication may be made between wireless power receivers. According to one embodiment, the state information of the wireless power transmitter may include information of the maximum quantity of supply power to be transmitted by the wireless power transmitter, the number of wireless power receivers to receive power from the wireless power transmitter, and the quantity of available power of the wireless power transmitter.

Meanwhile, hereinafter, the wireless power receiver for sharing power with another wireless power receiver through a bi-directional wireless power transmission scheme according to a first embodiment of the disclosure and a method for the same will be described.

### First Embodiment

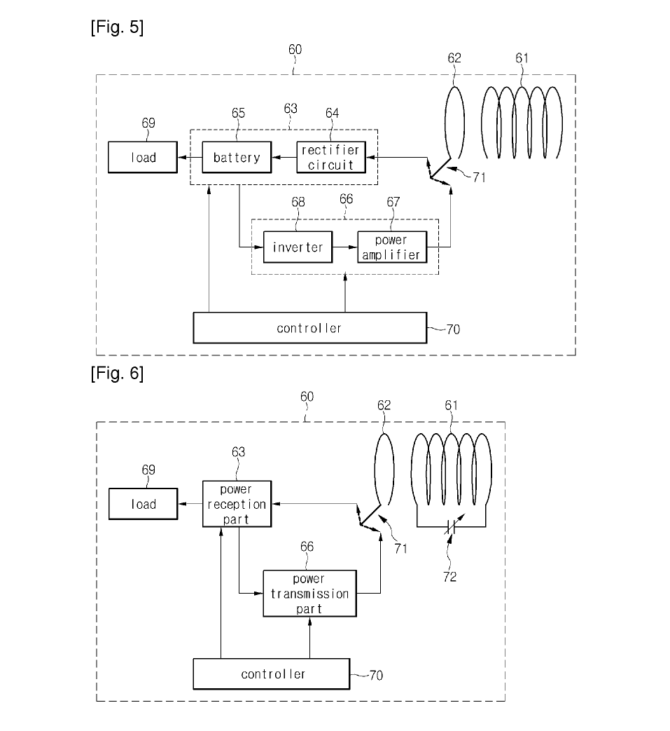

FIG. 5 is a block diagram showing the wireless power receiver according to the first embodiment of the disclosure.

Referring to FIG. 5, a wireless power apparatus 60 includes a reception resonance coil 61, a reception coil 62, a power reception part 63, a power transmission part 66, a load 69, a controller 70, and a switch 71.

The wireless power apparatus 60 may operate in one of a reception mode and a transmission mode according to the control of the controller 70. In other words, if the operating mode of the wireless power apparatus 60 is the reception mode, the wireless power apparatus receives power from the transmitter to perform the intrinsic function thereof. In contrast, if the operating mode of the wireless power apparatus 60 is the transmission mode, the wireless power apparatus 60 may transmit power stored therein to another receiver.

The reception resonance coil 61 and the reception coil 62 may receive or transmit power through a resonance phenomenon.

For example, if the operating mode of the wireless power apparatus 60 is the reception mode, the reception resonance coil 61 and the reception coil 62 receive power, which has been transmitted from the transmitter, and supply the power to the reception part 63.

In addition, if the operating mode of the wireless power apparatus 60 is the transmission mode, the power stored in the reception resonance coil 61 and the reception coil 62 may be transmitted to another receiver. In this case, the reception resonance coil 61 and the reception coil 62 perform the same operation as that of the transmission resonance coil and the transmission coil.

The reception resonance coil 61 may further include a variable capacitor. For example, as shown in FIG. 6, the wireless power apparatus 60 may change the resonance frequency thereof by adjusting the variable capacitor according to the control of the controller 70.

The reception part 63 includes a rectifier circuit 64 and a battery 65 to convert AC power received therein from the reception coil 62 into DC power to be charged.

In more detail, the rectifier circuit 64 may include a diode and a smoothing capacitor to convert AC power received therein from the reception coil 62 into DC power to be output. In addition, the battery 65 stores the DC power supplied from the rectifier circuit 64.

The load 69 receives the power from the reception part 63 to perform the intrinsic function of the receiver. In this case, the load 69 may be varied according to the types of the receiver, but the embodiment is not limited thereto.

The power transmitter 66 includes an inverter 68 and a power amplifier 67 to convert DC power received therein from the reception part 63 into AC power to be supplied to the reception coil 62.

In more detail, the inverter 68 converts DC power received therein from the reception part 63 into AC power. In addition, the power amplifier 67 amplifies the AC power to be supplied to the reception coil 62.

The switch part 71 can change a path according to the operating mode of the wireless power apparatus 60. For example, if the operating mode of the wireless power apparatus 60 is the reception mode, the switch part 71 connects the reception coil 62 to the reception part 63, and disconnects the reception coil 62 from the power transmitter 66. In contrast, if the operating mode of the wireless power apparatus 60 is the transmission mode, the switch part 71 connects the reception coil 62 to the power transmitter 66, and disconnects the reception coil 62 from the reception part 63.

The controller 70 controls the overall operation of the wireless power apparatus 60. In addition, the controller 70 controls the operation of the switch 71 according to the operating mode of the wireless power apparatus 60.

In this case, the controller 70 may determine the operating mode of the wireless power apparatus 60 according to the quantity of power stored in the power reception part 63 and the existence of the transmitter and other receivers around the wireless power apparatus 60.

For example, if the quantity of power stored in the wireless power apparatus 60 is less than a preset threshold value, the controller 70 can change the operating mode thereof to the reception mode. In other words, if the operating mode of the wireless power apparatus 60 is the transmission mode, and the quantity of the stored power is less than the preset threshold value, the operating mode of the wireless power apparatus 60 is changed to the reception mode, so that the wireless power apparatus 60 receives power from the transmitter.

In this case, before the controller 70 changes the operating mode thereof to the reception mode, the controller 70 determines the existence of a surrounding transmitter. Only if the transmitter exits, the controller 70 can change the operating mode thereof to the reception mode.

According to one embodiment, before the operating mode is changed to the reception mode, if the transmitter cannot supply power even when the transmitter exists, the operating mode of the wireless power apparatus 60 may be maintained at the transmission mode. According to one embodiment, the wireless power receiver 60 may receive the information of a state in which the transmitter cannot supply power through the in-band communication shown in FIG. 4. According to one embodiment, the wireless power receiver 60 may receive the information of the state in which the transmitter cannot supply power through an additional short range communication module. According to one embodiment, the short range communication module may be included in the wireless power transmitter and the wireless power receiver, and may employ a short range communication scheme such as ZigBee, Bluetooth, or WiFi.

If the quantity of power stored in the wireless power apparatus 60 is greater than a preset threshold value, the controller 70 can change the operating mode thereof to the transmission mode. In other words, if the operating mode of the wireless power apparatus 60 is a reception mode, and if the quantity of stored power is greater than the preset threshold value, the wireless power apparatus 60 changes the operating mode thereof to the transmission mode, so that power can be transmitted to another receiver. In this case, before changing to the transmission mode, the controller 70 determines if other receivers exist in the vicinity therein. Only if the other receivers exist, the controller 70 can change the operating mode of the wireless power apparatus 60 to the transmission mode.

According to one embodiment, before the operating mode is changed to the transmission mode, even if other receivers exist, if the receivers cannot receive power, the wireless power receiver 60 can maintain the operating mode thereof in the reception mode. According to one embodiment, the state that the receivers cannot receive power refers to the state that the receivers may have been fully (100%) charged with power.

According to one embodiment, the wireless power apparatus 60 can receive the information of the state that the receivers cannot receive power by using in-band communication shown in FIG. 4. According to one embodiment, the wireless power apparatus 60 may receive the information of the state in which the receiver cannot receive power through an additional short range communication module. According to one embodiment, the short range communication module may be included in the wireless power transmitter and the wireless power receiver, and may employ a short range communication scheme such as ZigBee, Bluetooth, or WiFi.

In addition, the controller 70 can change the resonance frequency of the wireless power apparatus 60 by adjusting the variable capacitor 72 of the reception resonance coil 61. Therefore, the controller 70 performs a control operation so that the resonance frequency of the wireless power apparatus 60 is the same as that of other receivers. Accordingly, if the operating mode of the wireless power apparatus 60 is the transmission mode, power can be transmitted to the receivers.

The controller 70 can measure the quantity of power stored in the power transmission part 63 described above.

Hereinafter, the operation of a related wireless power receiver when the wireless power apparatus 60 is in the reception mode or the transmission mode will be described in brief

When the operating mode of the wireless power apparatus 60 is the reception mode, the power transmitted by the transmitter is received by the reception resonance coil 61, so that AC current flows through the related reception resonance coil 61. In addition, the power received in the reception resonance coil 61 is transmitted to the reception coil 62 by electromagnetic induction.

The AC power received in the reception coil 62 is converted to the DC power through the rectifier circuit 64. In addition, the DC power is stored in the battery 65.

The power stored in the battery 65 is supplied to the load 69, so that the intrinsic operation of the wireless power apparatus 60 can be performed.

Meanwhile, if the operating mode of the wireless power apparatus 60 is the transmission mode, the power stored in the battery 65 is transmitted to the power transmitter 66. The DC power received in the power transmitter 66 is converted to AC power through the inverter 68. In addition, the AC power is amplified through the power amplifier and supplied to the reception coil 62.

The reception coil 62 induces AC current to the resonance coil 61 physically spaced apart from the reception coil 61 through electromagnetic induction. In addition, the power received in the reception resonance coil 61 is transmitted to other receivers, which make a resonance circuit together with the reception resonance coil 61, due to the resonance.

As described above, the wireless power apparatus 60 not only receive power from the transmitter, but also transmit power to other receivers, so that the wireless power can be effectively shared between the receivers.

Hereinafter, a wireless charging system to reduce the deviation of energy between areas by using a wireless power receiver having a bi-directional wireless power transmission function according to a second embodiment of the disclosure and the method for the same will be described.

### Second Embodiment

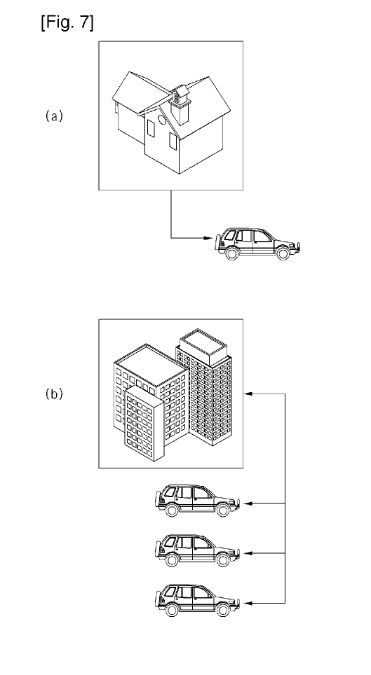

FIGS. 7(a) and 7(b) are views showing one scenario of a wireless charging system to reduce the deviation of energy between areas by using an electric vehicle having a bi-directional wireless power transmission function. In this case, the electric vehicle has the bi-directional wireless power transmission function to transceive energy.

Referring to FIG. 7(a), a person dwelling in the outskirts of a city charges an electric vehicle with power in a time zone that electric charges are lowered, that is, in the middle of the night or charges the electric vehicle with economical renewable energy generated through a solar power generation apparatus or a wind power generation apparatus installed in the premises. In this case, the electric vehicle receives energy from the wireless power transmitter installed in a home.

Referring to FIG. 7(b), a person dwelling in the outskirts of a city goes to a company/public organization located in a downtown area and parks the electric vehicle in a parking lot. In this case, the electric vehicle is parked in a space in which the wireless power transmission is available in the company/public organization.

The company/public organization receives power from the parked electric vehicle in a time zone in which the electricity charges are raised, and charges the electric vehicle with power in a time zone in which the electricity charges are lowered, so that the use ratio of power can be saved.

For example, a power managing server of the company/public organization requests wireless power transmission to the parked electric vehicle in the time zone in which the electrical charges are raised. Then, the electric vehicle parked in the parking lot supplies power to the power receiver installed in the building. This is because the electric vehicle not only has a function of wirelessly receiving power, but also has a function of wirelessly transmitting power.

Thereafter, the electric vehicle receives power from the power transmitter provided in a company in an office closing time zone in which the electric charges are relatively lowered. In this case, the company/public organization may calculate the quantity of power received from the electric vehicle and returns power to the electric vehicle. In addition, the company/public organization may calculate additional electric charges and may bill a driver of the electric vehicle for the electricity.

The energy deviation between the outskirt and the downtown area of a city can be reduced by wireless exchanging power using the electric vehicle having a bi-direction wireless power transmission function.

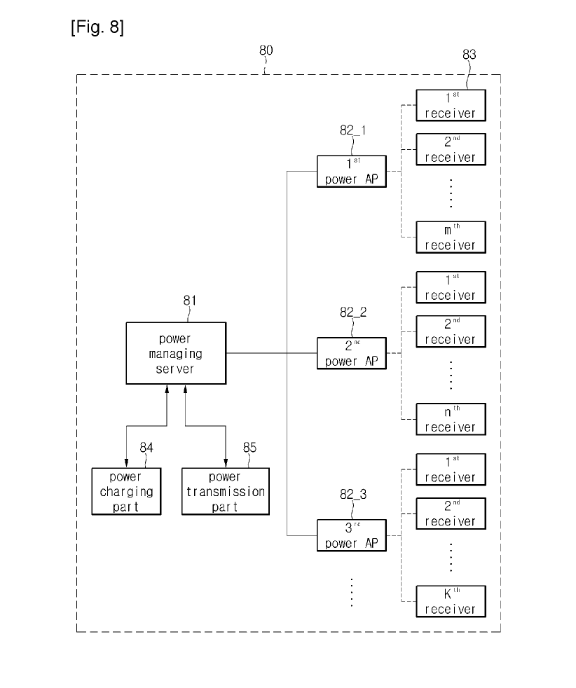

FIG. 8 is a block diagram showing a wireless charging system to effectively perform a power management in the company/public organization.

The wireless charging system 80 includes a power managing server 81, a plurality of power access points APs 82, a plurality of receivers 83, a power transmission part 84, and a power transmission part 85. In this case, the receivers 83 can wirelessly receive power, and the power AP 82 may include a wireless power transceiver.

The power managing server 81 controls the overall operation of the power management in the company/public organization. For example, the power managing server 81 controls the power APs 82, the power receiver 84, and the power transmitter 85 so that the power consumption in the company/public organization can be economically managed.

Each power AP 82 wirelessly supplies power to the receivers 83 existing in a coverage area thereof. In addition, each AP 82 can check the battery state of the receivers 83 by using in-band communication with the receivers 83.

Meanwhile, the power APs 82 need to restrict the power use in the company/public organization as much as possible in the time zone in which the electric charges are raised. Therefore, the power APs 82 can control wireless power transmission based on the battery states of the receivers under the control of the power managing server 81. For example, the power APs 82 can wirelessly transmit power to receivers having a lower battery level, and can stop the wireless power transmission to the receivers having a high battery level.

The receivers 83 wirelessly receive power from the power APs 82. Meanwhile, the receivers 83 may be equipped with a bi-directional wireless power transmission function. In this case, the receivers 83 may wirelessly share power therebetween. The receivers 83 include electronic devices such as a laptop computer or a cellular phone.

The power reception part 84 stores economical power from an external device. For example, as shown in FIG. 7, the power reception part 84 may receive power from the electric vehicle charged with power in a time zone in which an electric charge is lowered.

The power reception part 84 supplies the power for the management of the company/public organization in the time zone in which the electric charge is raised under the control of the power managing server.

The power transmission part 85 transmits power to an external device in the time zone in which the electric charge is lowered. For example, as shown in FIG. 7, at the office closing time zone in which the electric charge is lowered, the power transmission part 85 wirelessly charges power into the electric vehicle receiving power.

As described above, according to the wireless charging system of the embodiment of the disclosure, the power use in the company/public organization can be economically managed by using the receivers having the bi-directional wireless power transmission function.

Although a preferred embodiment of the disclosure has been described for illustrative purposes, those skilled in the art will appreciate that various modifications, additions and substitutions are possible, without departing from the scope and spirit of the invention as disclosed in the accompanying claims.

1. A wireless power apparatus comprising:
a coil to wirelessly transceive power with a power access point according to an operating mode of the wireless power apparatus;
a first power reception part to receive power through the coil;
a first power transmission part to transmit power through the coil; and
a switch to connect one of the first power reception part and the first power transmission part to the coil according to the operating mode of the wireless power apparatus,
wherein the operating mode of the wireless power apparatus is determined according to a power charge and a power use time.

2. The wireless power apparatus of claim 1, wherein the coil wirelessly receives power from the power access point if the operating mode of the wireless power apparatus is a reception mode.

3. The wireless power apparatus of claim 1, wherein the coil wirelessly transmits power to the power access point if the operating mode of the wireless power apparatus is a transmission mode.

4-19. (canceled)

20. The wireless power apparatus of claim 1, wherein a power managing server controls the wireless power apparatus and the power access point to transceive power according to the power charge and the power use time.

21. The wireless power apparatus of claim 20, wherein the operating mode of the wireless power apparatus is determined by the power managing server.

22. The wireless power apparatus of claim 1, wherein the first power reception part stores power received from the coil into a battery.

23. The wireless power apparatus of claim 22, wherein the first power transmission part transmits power stored in the battery through the coil.

24. The wireless power apparatus of claim 22, wherein the operating mode of the wireless power apparatus is changed according to quantity of power stored in the battery.

25. The wireless power apparatus of claim 24, wherein the operating mode is changed to a reception mode if the quantity of power stored in the battery is less than a threshold value, and
wherein the switch connects the first power reception part to the coil.

26. The wireless power apparatus of claim 24, wherein the operating mode is changed to a transmission mode if the quantity of power stored in the battery is greater than a threshold value, and
wherein the switch connects the first power transmission part to the coil.

27. The wireless power apparatus of claim 1, wherein the coil transceives power using resonance.

28. The wireless power apparatus of claim 22, the power access point checks a state of the battery of the wireless power apparatus using in-band communication.

29. The wireless power apparatus of claim 1, wherein a second power reception part stores power transmitted from the wireless power apparatus in a time zone in which the power charge is raised.

30. The wireless power apparatus of claim 29, wherein a second power transmission part provides power to the wireless power apparatus in a time zone in which the power charge is lowered.

31. The wireless power apparatus of claim 1, wherein the wireless power apparatus is an electric vehicle.
